(19) United States
(12) Patent Application Publication
(10) Pub. No.: US 2009/0085766 A1
(43) Pub. Date: Apr. 2, 2009

(54) "Hands free" type telephone kit for a motorcycle, the kit being remotely controlled from the handlebar

(76) Inventors: Henri Seydoux, Paris (FR); Bertrand Vignau-Lous, Paris (FR); Jerome Mathieu, Paris (FR); Guillaume Pinto, Paris (FR)

Correspondence Address: HAVERSTOCK & OWENS LLP, 162 N WOLFE ROAD, SUNNYVALE, CA, 94086, US

(21) Appl. No.: 12/082,725

(22) Filed: Apr. 11, 2008

(30) Foreign Application Priority Data
Sep. 28, 2007 (FR) 07/06809

(51) Int. Cl. G08C 19/00

(52) U.S. Cl. 340/825.72

(57) ABSTRACT

The kit comprises a helmet unit with a microphone, earpieces, circuits for processing and amplifying an audio signal, and for coupling with a remote telephone. A self-contained wireless remote control is releasably fittable on the handlebar. The remote control is in the form of a resilient clamp having two movable branches united by a hinge provided with resilient return means enabling it to be placed around the handlebar. The resilient return means then urge the two branches to clamp onto the handlebar in order to hold the device close to the fingers of the user who can thus access the various function keys of the remote control.

The invention relates to a wireless remote control device for motorcycles, and also to a “hands-free” type kit, in particular for controlling a mobile telephone, and making use of such a remote control device.

### BACKGROUND OF THE INVENTION

The invention is particularly suitable for users of motorcycles (including scooters, mopeds, etc.) seeking to access the various functions of an electronic appliance such as a mobile telephone, radio/audio system, or indeed an interphone with a passenger.

The invention is described more particularly in an application to wireless “hands-free” telephony, however this application is not limiting on the invention, which can be used for accessing the functions of any complex system used on board a motorcycle.

The invention relates in particular to systems that are “retrofitted” on motorcycles, thus involving certain specific constraints in terms of ergonomics, safety, and compatibility in order to enable them to be incorporated.

The system must be capable of being mounted on almost any motorcycle available on the market. It must also enable the user to have access in complete safety to the various functions thereof that the user might wish to control. In other words, the user must have access to these functions without glancing away from the road and without losing full control over the vehicle. Finally, the system must be capable of dissuading attempts at theft or vandalism when the motorcycle is parked.

Various remote control systems for motorcycles are known, in particular for controlling radio-listening, mobile-telephone, or passenger-interphone functions.

By way of example, DE 199 62 603 A1 describes a system with wireless connections between a “hands-free” telephony microphone-and-earpiece unit mounted on a helmet and a remote control unit mounted on the handlebar. Other devices for mounting on a motorcycle handlebar are described in US 2005/035856 A1, DE 203 17 439 U1, and US 2002/014565 A1.

Nevertheless, those remote controls are specialized, i.e. they are designed to handle a single system (either a telephone, or an interphone, . . . ). In addition, they are generally somewhat inconvenient to install and to use, in other words they are not sufficiently ergonomic.

The above-mentioned difficulties are also made considerably worse if it is desired to use a single remote control to handle a plurality of different devices that are capable of producing a corresponding plurality of audio signals: telephone, integrated radio, MP3 player, . . . : the development of a complex system incorporating a large number of functions and capable of being retrofitting on a motorcycle involves making a large number of different controls available to the user.

If it is desired for the main unit of such a system to be capable of being positioned on the user's helmet (thus making it easy to connect a microphone and earpieces), integrating all of the controls on that helmet unit does not make it possible to satisfy the above-described ergonomic and safety constraints.

The invention proposes remedying those various drawbacks and limitations by means of a novel “hands-free” type kit for a motorcycle that implements a suitable wireless remote control device.

Essentially, the solution proposed by the invention relies on using two separate elements: a main unit and a self-contained wireless remote control device. The main unit that incorporates the various electronic modules and the elements for acquiring and playing back audio signals constitutes the core of the system and is fastened to the user's helmet. The wireless remote control device enables the user to access the various functions of the main unit and is designed to be fastened on a handlebar element, e.g. the left handgrip of the motorcycle.

More precisely, as described in above-mentioned DE 199 62 603 A1, the remote control device is contained in a self-contained element suitable for being fastened to a portion of the motorcycle handlebar, the device being provided with a plurality of function keys accessible to a user and with wireless transmission means controlled by activating any one of the function keys.

### OBJECTS AND SUMMARY OF THE INVENTION

In a manner characteristic of the invention, the wireless transmission means are suitable for transmitting an RF signal that is encoded as a function of which function key is activated. The self-contained element is in the form of a resilient clamp comprising two branches that are movable relative to each other, each of the branches being generally elongate in shape, curved lengthwise, and presenting a concave side facing towards the other branch, the two branches being united by a hinge provided with resilient return means urging the two branches towards each other, and the two branches being movable between: a clamp-open position under external force applied against the resilient return means, with the spacing between the two branches then sufficing to enable the free distal portions of the branches to be placed on either side of said portion of the motorcycle handlebar; and a clamp-closed position in which the resilient return means urge the two branches to clamp onto said portion of the handlebar in order to fasten the device onto the handlebar in the proximity of the user's fingers.

The two branches may comprise a front branch facing towards the user when the device is held clamped on the handlebar, with an apparent face of the front branch carrying at least some of said function keys.

According to various subsidiary advantageous characteristics:
the apparent face of the front branch also carries a non-moving tactile marker positioned in predetermined manner relative to the function keys placed on said apparent face; these functions may in particular be disposed substantially in a common overall direction and they may be organized in two distinct groups on either side of said non-moving tactile marker;
these function keys may in particular comprise: on one side of the non-moving tactile marker, a first radiotelephone-control key and a first browsing key, and on the opposite side, a second radiotelephone-control key, and a second browsing key; they are advantageously formed in relief and produce a tactile effect on being actuated;
the rear branch may also carry a function key, in particular a source-selection key; and
at least one of the two branches has a coating of non-slip material on its inside face suitable for coming into contact with the handlebar, and presents a right section of convex shape in the region of its inside face that is suitable for coming into contact with the handlebar.

The invention also provides a “hands-free” type kit for a motorcycle, the kit comprising both: a main unit removably fittable to a piece of equipment such as a helmet, and comprising a microphone, earpieces, a circuit for processing and amplifying an audio signal, and a circuit for coupling with a remote telephone; and a self-contained wireless remote control device as set out above.

According to various subsidiary characteristics that are advantageous, the main unit may further comprise:
a source concentrator for selectively connecting said circuit for processing and amplifying an audio signal to an active source selected from said remote telephone and at least one other radio/audio signal source;
an internal radio broadcast receiver circuit, the signal delivered by said receiver circuit being suitable for being selected by the source concentrator; and
a connector suitable for being connected to an external audio signal source, the signal received by said connector being suitable for being selected by the source concentrator.

The function keys of the remote control device are then multifunction keys of functions that can be redefined depending on which audio signal source is selected by the source concentrator of the main unit.

### BRIEF DESCRIPTION OF THE DRAWINGS

There follows a description of an embodiment of the device of the invention, given with reference to the accompanying drawings, in which the same numerical references are used from one figure to another to designate elements that are identical or functionally similar.

FIG. 1 is an overall view of the kit of the invention showing the main unit, the self-contained remote control, and a telephone coupled to the main unit.

FIG. 2 is an enlarged view of the remote control device of the invention, showing how the device is installed on a motorcycle handlebar, with the various function keys that can be actuated by the user.

FIG. 3 is a three-quarters perspective view from behind showing the remote control device of FIG. 2.

FIG. 4 is a section view on a horizontal plane through the handgrip and the remote control device.

FIG. 5 is a view on a larger scale corresponding to a detail marked V in FIG. 4.

FIG. 6 is a cross-section view of the remote control device of 2 and 3.

FIG. 7 is a block diagram showing the various functional elements of the main unit and of the remote control device.

### MORE DETAILED DESCRIPTION

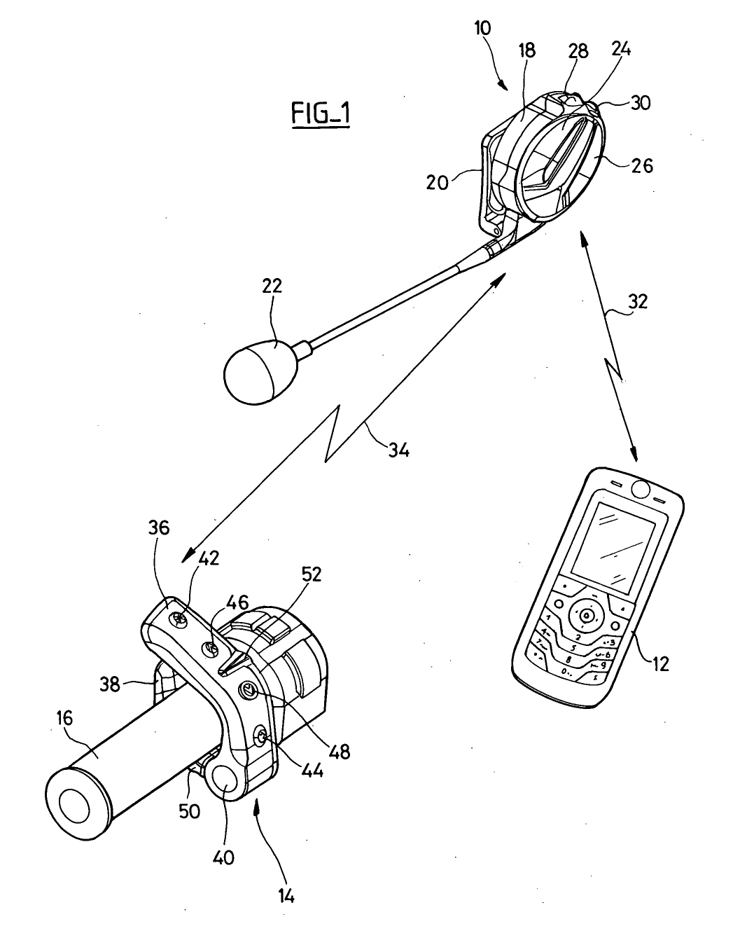

In FIG. 1, reference 10 designates the main unit of a “hands-free kit” of the invention.

The main unit 10 has wired, or most advantageously wireless, coupling means for coupling with a mobile telephone 12, e.g. via a radio link of the Bluetooth type (registered trademark of Bluetooth SIG, Inc.). The Bluetooth specifications provide for the possibility of remotely controlling all of the functions of a mobile telephone such as answering, hanging up, dialing, browsing through menus and directories, etc., by means of a both-way wireless link, providing full remote control of the mobile telephone and completely replacing its keypad. The presence of the mobile telephone within the range of the hands-free unit is detected in entirely automatic manner, so there is no need for the user to take out the mobile telephone, which can remain in a jacket pocket, in a bag, or in a briefcase without it being necessary for the user to take any action in order to activate the unit. The unit becomes immediately operational as soon as the user together with the telephone 12 comes close thereto, and all the usual controls can be executed via the unit 10 (nevertheless, it should be observed that the invention is equally applicable to a configuration in which there is a wired connection between the unit 10 and the telephone 12, in which case the unit is provided with a pluggable connector for providing coupling between the telephone and the adapter).

The main unit 10 is controlled by a remote control 14 removably mounted on a handlebar element, e.g. on the left handgrip 16 of a motorcycle. It is the left handgrip that is selected because it is not possible for the user to make use of the right hand for operating the remote control insofar as it is the right hand that is used for operating the accelerator.

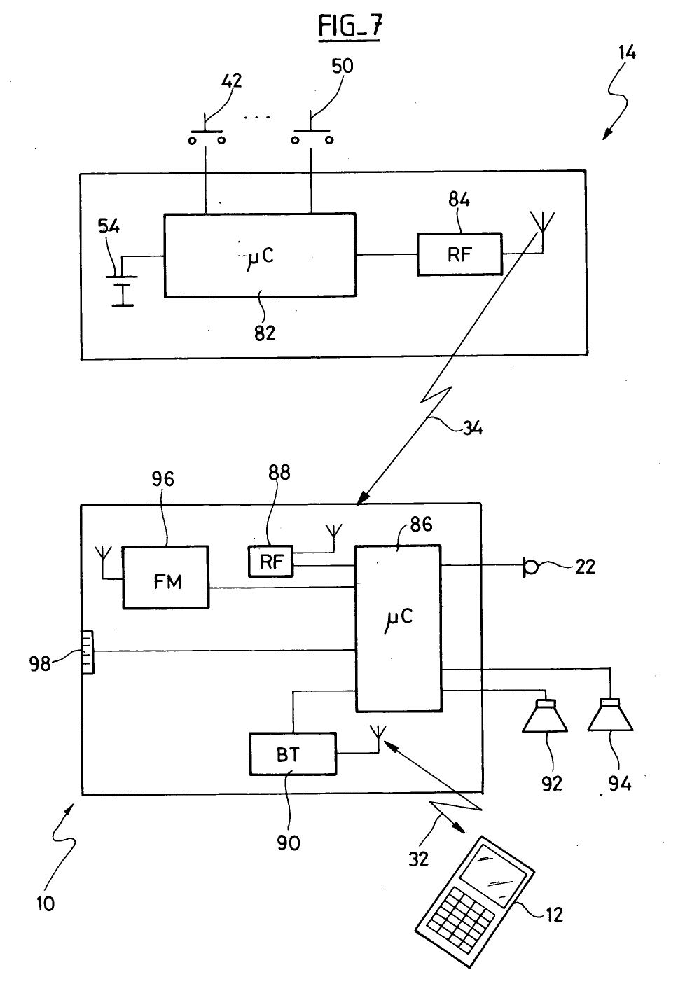

The main unit 10 comprises a block 18 containing various electronics circuits (described below with reference to FIG. 7), and it is provided with a clip 20 enabling it to be clipped to the user's helmet rim. The unit 10 is also connected to a microphone 22 and to earpieces (not shown in FIG. 1) capable of being placed inside the helmet. The unit 10 also has two control keys 24 and 26 (e.g. hang up/answer, on/off, etc. keys), together with two keys 28, 30 for adjusting the volume played back by the earpieces.

The main unit 10 includes means for establishing a first both-way wireless link with the mobile telephone 12, e.g. by using Bluetooth protocols and profiles as explained above, and also means for setting up a second wireless link 34 that is a one-way (receive) link with the remote control device 14.

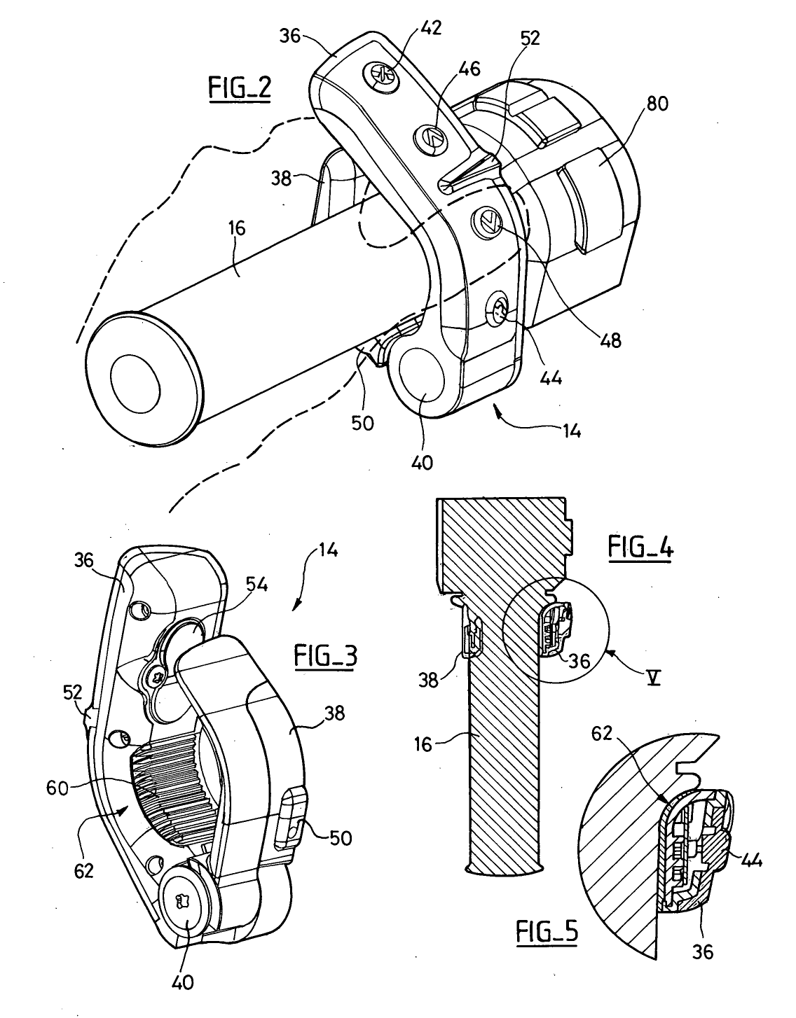

The remote control device 14, shown in greater detail in FIGS. 2 to 6, comprises two branches 36, 38 of generally elongate shape, namely a front branch 36 facing towards the user, and an opposite or rear branch 38. These two branches are hinged to each other about a common axis 40 that is provided with a spring. The resulting system is in the form of a clamp and can exert a clamping force on the handgrip 16 (or any other accessible portion of the handlebar) that serves to hold the device 14 on the handgrip.

The front branch 36 carries four function keys 42, 44, 46, and 48, and the rear branch 38 carries a fifth key 50.

By way of example, the keys are allocated to the following functions:
key 42: answer (telephone function);
key 44: hang up (telephone function);
key 46: browse forwards through a directory menu (telephone function), next station (radio function), next track (external audio source function);
key 48: browse backwards through a directory menu (telephone function), preceding station (radio function), preceding track (external audio source function); and
key 50: select source; telephone, radio, or external audio source.

The various keys are placed in such a manner that the user can access them naturally with a gloved hand and without letting go of the handgrip. The keys 42, 44, 46, and 48 located on the front branch 36 are substantially in alignment so as to be accessible with the thumb. The key 50 disposed on the rear branch is designed to be actuated with the index finger. Tactile markers are provided to enable the user to identify the various keys easily and to access them without glancing away from the road: thus, a portion in relief 52 is provided on the front branch acting as a separator between the keys 42, 46 on one side and 44, 48 on the other; furthermore, the keys are shaped to project so as to be immediately felt by the rider without needing to look at the remote control; the keys also produce a tactile effect (a “click” effect) when they are actuated, so that the user can feel this actuation immediately.

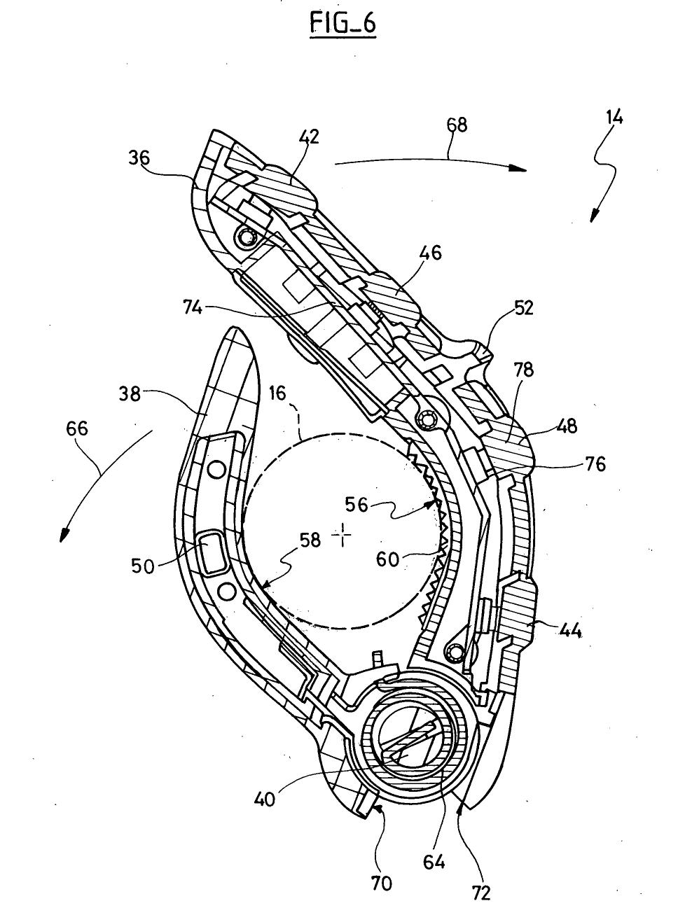

Apart from a battery housing 54 (FIG. 3), the respective inside faces 56 and 58 of the front and rear branches 36 and 38 present a rounded concave shape (FIGS. 3 and 6) of dimensions selected to optimize contact area with the handgrip, taking account of the various diameters and shapes that are likely to be encountered from one model of motorcycle or scooter to another. At least one of the inside faces is also coated in a rough, non-slip material 60, e.g. an elastomer, to prevent any turning or sliding of the remote control device around the handgrip, in particular while the keys are being pressed.

It should also be observed (FIGS. 3 to 5) that the region 62 of the front branch 36 facing towards the inside of the handlebar presents a convex rounded shape enabling it to fit more closely to the handgrip 16 in this region (see FIG. 4). This enables the remote control device 14 to be placed as close as possible to the central axis of the motorcycle; once mounted on the handgrip, the device must not hinder access to existing controls, in particular the brake controls and the “combo” buttons 80 (controlling turn indicator lights, headlights, etc.) that must continue to be capable of being actuated by the user's fingers.

The remote control device is designed to be both completely self-contained and removable.

For this purpose, the two branches 36, 38 are hinged at 40 about a common axis provided with a spring 64 enabling the device to be clamped strongly onto the handgrip 16: the user can put the remote control unit into place and can remove it very easily before and after each use by splaying apart the two elements that make it up (arrows 66, 68), with the stroke being limited by abutments 70, 72.

This fastener system makes it possible to avoid any attempt at theft or vandalism while parked outside. It also makes it possible to overcome the constraint constituted by the various diameters of handgrips for different models of motorcycle, with the spacing between the branches of the clamp adapting automatically to the dimensions of the handgrip.

The various electronic elements of the remote control device 14 are mounted on a flexible circuit 74 in the form of an elongate ribbon carrying the various active and passive components, and also contactors 76 that are placed in register with the keys 42, 46, 48, 44, and 50. The keys are advantageously molded out of an elastic material 78 that serves to provide both the deformability and the leakproofing that are required.

FIG. 7 is a block diagram showing the main functional elements of the remote control 14 and of the main unit 10.

The remote control device 14 essentially comprises a microcontroller 82 connected to the contactors of the keys 42, 44, 46, 48, and 50, and to a circuit 84 that transmits a coded radiofrequency (RF) signal to the main unit 10, the code being a function of which key has been actuated.

The main unit 10 is organized around a microcontroller 86 connected to a circuit 88 that receives the RF signal transmitted by the remote control device 14. The microcontroller is also connected to a Bluetooth interface transceiver circuit 90 enabling a both-way link 32 to be established with the remote mobile telephone 12. Advantageously, the unit 10 also includes an integrated frequency modulated (FM) radio receiver 96 together with a connector 98, e.g. a jack type audio connector or a Mini-USB type digital connector for enabling the unit 10 to be connected to an external source such as an MP3 player.

The various available sources (telephone, radio, player) can be selected merely by the user pressing on the source-selection key 50 of the remote control with the index finger. The keys 42 and 44 may be associated with answer/hang up functions while the keys 46 and 48 are associated, depending on which source has been selected, with changing station (radio function), changing track (audio function), or indeed browsing through a menu, e.g. a telephone directory (telephone function). To make the device more ergonomic, these functions can be accompanied by voice confirmations and by voice commands. By way of example, such functions can be implemented by the microcontroller 86 being constituted by a digital processor such as the P5+ chip from the supplier Parrot SA, Paris, France.

What is claimed is:

1. A wireless remote control device for a motorcycle, the device being contained in a self-contained element suitable for being fastened to a portion of the motorcycle handlebar, the device being provided with a plurality of function keys accessible to a user and with wireless transmission means controlled by activating any one of the function keys;
wherein the wireless transmission means are suitable for transmitting an RF signal that is encoded as a function of which function key is activated; and wherein said self-contained element is in the form of a resilient clamp comprising two branches that are movable relative to each other, each of the branches being generally elongate in shape, curved lengthwise, and presenting a concave side facing towards the other branch, the two branches being united by a hinge provided with resilient return means urging the two branches towards each other, and the two branches being movable between:
a clamp-open position under external force applied against the resilient return means, with the spacing between the two branches then sufficing to enable the free distal portions of the branches to be placed on either side of said portion of the motorcycle handlebar; and
a clamp-closed position in which the resilient return means urge the two branches to clamp onto said portion of the handlebar in order to fasten the device onto the handlebar in the proximity of the user's fingers.

2. The remote control device of claim 1, in which the two branches comprise a front branch facing towards the user when the device is held clamped on the handlebar, and in which an apparent face of the front branch carries at least some of said function keys.

3. The remote control device of claim 2, in which the apparent face of the front branch also carries a non-moving tactile marker positioned in predetermined manner relative to the function keys placed on said apparent face.

4. The remote control device of claim 3, in which the function keys placed on said apparent face of the front branch are disposed thereon substantially in a common overall direction and they are organized in two distinct groups on either side of said non-moving tactile marker.

5. The remote control device of claim 4, in which the function keys placed on said apparent face of the front branch comprise, on one side of the non-moving tactile marker, a first radiotelephone-control key and a first browsing key, and on the opposite side, a second radiotelephone-control key, and a second browsing key.

6. The remote control device of claim 2, in which the function keys placed on said apparent face of the front branch are keys formed in relief and that produce a tactile effect on being actuated.

7. The remote control device of claim 2, in which the rear branch carries a function key.

8. The remote control device of claim 6, in which the function key carried by the rear branch is source-selection key.

9. The remote control device of claim 1, in which at least one of the two branches has a coating of non-slip material on its inside face suitable for coming into contact with the handlebar.

10. The remote control device of claim 1, in which at least one of the two branches presents a right section of convex shape in the region of its inside face that is suitable for coming into contact with the handlebar.

11. A “hands-free” type kit for a motorcycle, the kit comprising:
a main unit removably fittable to a piece of equipment such as a helmet, and comprising a microphone, earpieces, a circuit for processing and amplifying an audio signal, and a circuit for coupling with a remote telephone; and
a self-contained wireless remote control device;
wherein said self-contained wireless remote control device is a device according to claim 1.

12. The “hands-free type” kit of claim 11, in which said main unit further comprises a source concentrator for selectively connecting said circuit for processing and amplifying an audio signal to an active source selected from said remote telephone and at least one other radio/audio signal source.

13. The “hands-free type” kit of claim 12, in which said main unit further comprises an internal radio broadcast receiver circuit, the signal delivered by said receiver circuit being suitable for being selected by the source concentrator.

14. The “hands-free” type kit of claim 12, in which said main unit further comprises a connector suitable for being connected to an external audio signal source, the signal received by said connector being suitable for being selected by the source concentrator.

15. The “hands-free” type kit of claim 12, in which the function keys of the remote control device are multifunction keys of functions that can be redefined depending on which audio signal source is selected by the source concentrator of the main unit.
